(19) United States
(12) Patent Application Publication
(10) Pub. No.: US 2007/0107136 A1
(43) Pub. Date: May 17, 2007

(54) Method and apparatus for wet treatment of textiles and textile articles at low temperatures

(76) Inventors: Xiao-Ming Tao, Hong Kong (CN); Wei Chen, Hong Kong (CN); Ching-Yee Lung, Hong Kong (CN)

Correspondence Address: COOPER & DUNHAM, LLP, 1185 AVENUE OF THE AMERICAS, NEW YORK, NY, 10036, US

(21) Appl. No.: 11/505,741

(22) Filed: Aug. 16, 2006

Related U.S. Application Data
(60) Provisional application No. 60/708,763, filed on Aug. 17, 2005.

(51) Int. Cl. C11D 3/00

(52) U.S. Cl. 8/115.51

(57) ABSTRACT

The invention provides a method and apparatus of applying ultrasound energy in wet treatment of textiles, particularly in a dyeing process. By keeping the articles to be dyed within an optimal zone of the sonoreactor, the method achieves a high dyeing efficiency, making it possible to dye at a low temperature, with little or no use of chemical assistants while achieve a dyeing quality comparable with conventional dyeing method relying on high temperatures and/or use of chemical assistants. The apparatus suitable for practicing the method uses a conveyor belt having two layers of meshes between the articles to be dyed are sandwiched exerting no tension on the articles. The conveyor belt can be configured to travel within the optimal zone of the sonoreactor, whereby constraining the articles under dyeing within the optimal zone. With such a conveyor belt, small pieces of articles can be dyed just as easily as the large ones.

### CROSS REFERENCE TO RELATED APPLICATION

Pursuant to 35 U.S.C. § 119(e), this application claims priority to U.S. Provisional Application No. 60/708,763, filed Aug. 17, 2005, the contents of which are hereby incorporated by reference.

### FIELD OF THE INVENTION

The present invention relates to a process of wet-treatment of textile and textile articles. Particularly, it relates to a low temperature wet treatment process and equipment suitable for coloring a variety of textile and textile articles, such as natural or synthetic fibers, yams, fabrics, garments (larger or small), using a novel configuration that maintaining the articles under treatment staying and/or moving within optimal dyeing zones of one or more ultrasonic generators.

### BACKGROUND OF THE INVENTION

The wet treatment process assisted with ultrasound energy has been employed or suggested for textile coloration. In practice, however, the efficacy of coloration is often limited due to unevenness of cavitations formed in dyeing equipment, such as, a common ultrasonic bath. To compensate the lack of cavitation uniformity, methods such as heating or using auxiliary chemicals have been used in the dyeing process assisted by ultrasound generators (or transducers), which themselves may also need to operate at higher frequencies to achieve a satisfactory efficacy. Thus, the conventional textile dyeing treatment is a major wet process which consumes much energy and water and releases large quantities of effluent to the environment. High temperature, high pressure or auxiliary chemicals are needed especially for those synthetic fabrics such as polyester, causing serious pollution problems and consumption of a large amount of energy, thereby increasing the cost of production. There is another disadvantage because, at high temperatures, it is difficult to dye those natural/synthetic blend textiles, such as cotton or wool/polyester blends. Furthermore, increasingly stringent environmental legislations and a much more competitive market demand new efficient methods for coloration in the textile industry.

Although over the years some progress has been made, there remain great challenges for substantially and effectively achieving energy savings by dyeing textiles at a low temperature, for reducing processing times, and for causing few environmental problems with reduced consumption of auxiliary chemicals, etc. For example, in U.S. Pat. No. 6,381,995, microwave irradiation was applied to the goods undergoing coloration, in order to heat them to about 100-130° C. under a low bath ratio, tensionless, and short-term dyeing process. U.S. Pat. No. 5,512,062 describes a method, apparatus, and related dye compositions for dyeing textiles which operates at high pressures, is open to the atmosphere, and does not require the steaming of the textile to set or fix the dye to the textile; specifically, a multi-temperature textile dyeing method (between 70-120° C.) which achieves a more complete and even dyeing of the textile in a shorter period of time. In U.S. Pat. No. 5,540,740, a micro-emulsion dyeing process for polyester fibers was explored by adding dyestuff and a dye solubility assistant agent selected from the group of short chain alcohols, dyeing polyester fibers at room temperature for 1-3 hours, washing the polyester fibers with a nonionic washing agent and thereafter drying the dyed polyester fibers. In U.S. Pat. No. 5,571,291, low-temperature dyeing additives for protein fiber products were used and served to relax the higher-order structures of the protein fibers before dyeing or during dyeing, to thereby swell the fibers, thus rendering the fibers readily dyeable without being detriment to the properties thereof.

There are a few patents related to the ultrasound-aided dyeing processing. European Pat. No. EP0373119 describes a process and apparatus for preparing a dye solution in textile coloration, in particular for reactive and vat dyes of various solubility. A high color yield was claimed. It covers a process of preparing the dyeing solution and a device to do it. The application of ultrasonic reactors is not during the dyeing or wet treatment processes. Thus the apparatus is a preparation unit added to the dyeing bath. The dyeing solution is heated to 30-80° C. In U.S. Pat. No. 4,419,160, ultrasound technology is used for thermoplastic non-woven fabric dyeing. The ultrasonically bonded point bonds of non-woven fabric are dyed by applying liquid dye to the contacting crossing points of the fibers before or at the same time that they are bonded by the application of ultrasonic energy, such energy being used not only to effect the point bonds but also to drive and fix the dye in such point bonds. That invention was focused on the dyeing of non-woven fabrics and more particularly, to the dyeing of fabric made of ultrasonically fusible fibers and fabrics.

Ahmad WYW and Saligram AN reported the low-temperature dyeing of polyester fabric using ultrasound. For details, see Ahmad, M. Y. W, and M. Lomas, “The low-temperature dyeing of polyester fabric using ultrasound”, Journal of Society of Dyers and Colorists, 112(9), 245-248 (1996) and Saligram, A. N., S. R. Shukla, and M. Mathur, “Dyeing of polyester fiber using ultrasound”, Journal of the Society of Dyers and Colorists, 109, 263-266 (1993). The advantages of being able to dye or print polyester fabrics at temperatures of 50° C., particularly for such methods as batik printing where wax is used, are discussed. Polyester fabrics were dyed in an ultrasonic bath using 3 disperse dyes. However, their results were not encouraging: the fabrics obtained were not generally as good as those that can be obtained in conventional high-temperature processes.

As mentioned in the above, ultrasound has been used in textile coloration. However, due to the problem of directional sensitivity of the sonoreactor, the active cavitational volume is not evenly distributed throughout the dyeing bath, with strong cavitations in areas close to the surface of the sonoreactor while less cavitations in most other areas. In order to have sufficient coloration in all the areas within the dyeing bath, it is necessary to increase the operating frequency of sonoreactor, increase the temperature, increase the process time, and/or add auxiliary chemicals. Thus, there is a need for new ways of applying ultrasonic energy to wet textile treatment.

### SUMMARY OF THE INVENTION

One object of the present invention is providing an ultrasound energy assisted wet processing method for textile coloration, which requires low temperatures, low energy consumption, low or no auxiliary chemicals, and/or short processing time, and at the same time maintains a satisfactory quality of coloration. This invention, using a constraining net to keep the articles under coloring either staying (in a batch mode) or continuously traveling (in a continuous mode) within optimal zones where ultrasonic cavitations are the most vigorous, brings the ultrasound into play to a much greater extent so that articles can be dyed under lower energy consumption and higher efficiency. The design of the constraining net (attached in the bath or on the conveyor belt) can be based on the types of articles under dyeing and it is within ordinary skill of the people in the art to make a constraining net or other means that can confine the articles under coloring staying or moving in the optimal zone of the sonoreactor. Similarly, the sonoreactor can be conventional ones or ones with specific configurations according to the requirements under particular situations. People of ordinary skill in the art are capable of determining the location of the optimal zone for dyeing and the route taken by the conveyor around the sonoreactor, which obviously varies in each particular situation. Location of the optimal zone depends on the ultrasound system employed. For example, because the location of transducers and geometric configuration of the ultrasound bath are fixed, the optimal distance from the sonoreactor's surface is localized at the middle of the container based on the propagation and reflection of the ultrasound waves in the bath. Also, the density of the medium undergoes periodic alterations with regions of alternating compression and rarefaction. In the examples described below, a relative agile sonoreactor was used, which is an ultrasound horn. The horn was immersed under the liquid medium at approximately 2 cm depth. Compared with the ultrasound bath, the geometry and space of the container (an experimental cell) with textile samples, was unfixed. The optimal zone should be between the bottom of cell and the tip of the horn depending on the capacity of the cell. Therefore, the conveyor belt with textiles could be raised or lowered to adjust the distance between the bottom of the cell and the tip of the horn.

The method of this invention is applicable to various textile materials, including synthetic, natural fabrics and their blends. By reducing the dyeing temperature, processing time and chemical consumption, the fabrics after dyeing possess qualities of better fastness, touch, air permeability and elasticity. In addition, the method of the present invention has applications other than textile coloration. It is useful for textile finishing, such as, reduction of surface crystallinity of polymeric textile materials and surface functionalization of textiles by doping or coating with nanomaterials at low temperature, etc.

The various features of novelty which characterize the invention are pointed out with particularity in the claims annexed to and forming a part of this disclosure. For a better understanding of the invention, its operating advantages, and specific objects attained by its use, reference should be made to the drawings and the following description in which there are illustrated and described preferred embodiments of the invention.

### BRIEF DESCRIPTION OF DRAWINGS

FIGS. 1 and 2 show the pictures taken from the polyester fabrics dyed under ultrasound according to the present invention and conventional methods.

FIGS. 3 and 4 show the pictures of cotton and linen fabrics dyed under ultrasound according to the present invention and conventional methods.

FIG. 5 shows the picture of wool fabrics dyed under ultrasound according to the present invention and a conventional method.

FIG. 6 depicts ultrasound-assisted dyeing apparatus with single ultrasonic source arranged according to the present invention.

FIG. 7 depicts ultrasound-assisted dyeing apparatus with multiple ultrasonic sources arranged according to the present invention.

FIG. 8(a) is an enlarged section view of the sandwich structure of the conveyor as shown in FIGS. 6 and 7, while FIG. 8(b) is the top view of a typical mesh layer of the conveyor.

### DETAILED DESCRIPTION OF PREFERRED EMBODIMENTS

In the embodiment described below, ultrasound dyeing was performed in a batch mode, as opposed to a continuous mode. The high efficiency of ultrasound assisted process of the present invention is accomplished by arranging and distributing single or multiple-ultrasonic transducers to a container filled with a dye solution comprising sufficient amount of water, in which the dyed goods can be immersed completely. Through some routine testing which can be conducted with ordinary skill in the art, the number, location, and combination of operating frequency and power of the ultrasonic transducers are particularly configured relative to the size and dimensions of the dye container so that entire dye solution is substantially within an optimal zone where cavitations are sufficiently vigorous and uniform for efficient and low temperature dyeing or other types of fabric treatments. The treatment system, which is open to the air, is subjected to irradiating ultrasound below 25 KHz. Pretreatment with/without swelling agents may be optionally carried out before dyeing, depending on the characteristics of different textile materials to be treated.

In the testing examples described below, a typical lab-scale setup was used. The bath was a 100 mL beaker or an experimental cell; the solution was 100 mL; Ultrasound, with a frequency of 25 kHz, was introduced into the reactive liquid with a titanic alloy horn with power output adjustable between 0-900 W (JY92-2D, NINBO SCIENTZ BIOTECHNOLOGY CO., LTD). The ultrasound horn was positioned in the bath supported by bracket which also is commercially available.

Several different dyes for synthetic and nature fabric were surveyed to determine the best potential applications of ultrasound in terms of dyes, chemicals, processes, and machines. It was determined, for example, that dispersed dye was used for polyester, direct dye for cotton and linen, and acid dye for wool. Before the ultrasound assisted dyeing process, polyester, cotton and linen fabrics were optionally pretreated by padding with a swelling agent. For comparison, conventional dyeing method for each type was also conducted.

The ultrasonic dyeing process was performed with no heating. The temperature of the dye solution may increase due to ultrasound cavitations. Depending on the employed ultrasound intensity, ultrasonic irradiation time and dye solution volume, the temperature was in the range of 50-70° C.

Ultrasound-assisted Dispersed Dyeing for Polyester Fabric

Ultrasound assisted dispersed dyeing for polyester fabric was conducted under ambient condition. In the dyeing solution, the ratio of dispersed dyes to the article to be dyed was 1:50. The operating frequency and intensity of the ultrasound employed were 25 KHz and 850 W, respectively, and the irradiation time is in the range of 20-30 minutes. Solution temperature arose by the cavitation was in the range of 60-70° C.

For comparison, a conventional dispersed dyeing process was conducted at a high temperature, either at 90° C. with carrier for 30 minutes or at 130° C. with pressure for 30 minutes. In the dyeing solution, the ratio of dispersed dyes to goods to be dyed is the same with that for ultrasound dyeing (i.e., 1:50), the ratio of dispersing agent to dye is 6:1, carrier to dye is 30:1, and acetic acid to dye is 3:1.

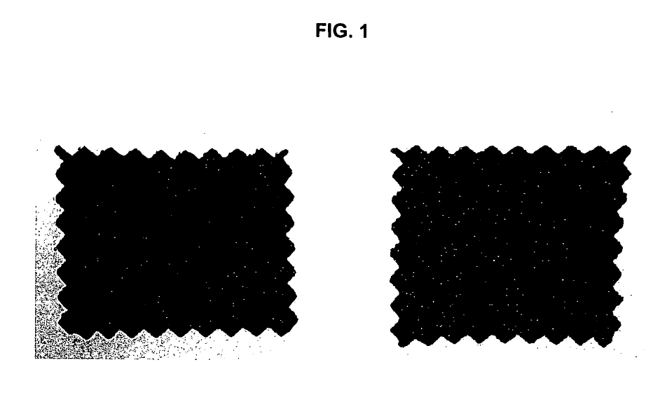

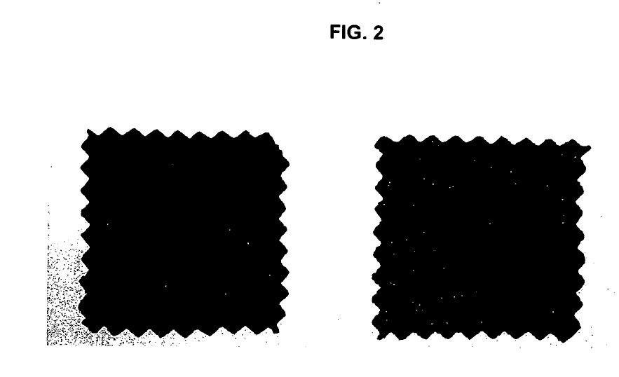

FIG. 1 shows the pictures taken from the polyester fabrics dyed under ultrasound and conventional methods, comparing the dyeing effect of both methods. For the ultrasound dyeing conducted in the dyeing solution, the ratio of dispersed dyes to the article to be dyed was 1:50. For the conventional dyeing conducted in the dyeing solution, the ratio of dispersed dyes to the article to be dyes is the same with that one for ultrasound dyeing. In addition, a dispersing agent, carrier and acetic acid were added. The ratios to dye are 6:1, 30:1 and 3:1 respectively. The left side (sample C) is the polyester fabric with ultrasound dyeing method with no heating for 20 minutes according to the present invention while the right side (sample A) is polyester fabric dyed with the conventional method with carrier at 90° C. for 30 minutes. In FIG. 2, a higher dye concentration was used: two times of concentration as used FIG. 1, that is, the ratio of dispersed dyes to the article to be dyed was 1:25. When dyeing under conventional method, the ratios of dispersing agent, carrier and acetic acid to dye kept the same as with the conventional method used in FIG. 1. Again, the left side (sample D) is polyester fabric, dyed with the ultrasound method, no heating for 20 minutes, and the right side (sample B) is with the conventional method with carrier heated to 130° C. for 30 minutes. Table 1 provides the color values of the dyed fabrics (i.e., samples A, B, C and D) under conventional and ultrasound dyeing conditions.

TABLE 1
Color values of the polyester fabrics dyed under ultrasound and
conventional methods

| Sample | | | | |
|---|---|---|---|---|
| Code | FABRIC | X | Y | Z |
| A | Polyester-Carrier | 9.540 | 9.812 | 31.163 |
| B | Polyester-HT130° C. | 7.245 | 7.068 | 25.629 |
| C | Polyester-Ultrasound | 9.496 | 9.764 | 31.830 |
| D | Polyester-Ultrasound/H- | 5.227 | 4.782 | 18.773 |
| | concentration | | | |

X, Y, Z are tristimulus values used to define colors. If two colors have the same tristimulus values, they will look alike under the same viewing conditions by a normal observer. For A, B & C, (Polyester-Carrier, Polyester-HT1300C & Polyester-Ultrasound) the three dyed fabrics have almost the same X, Y, Z values indicating that color of the fabrics under conventional and ultrasound dyeing look alike. But for D (Polyester-Ultrasound/H-concentration) the X, Y & Z values are significantly different from that of A, B & C, this means that absorption rate is increased when the ultrasound dyeing is carried out under high dyes concentration.

Ultrasound-Assisted Direct Dyeing for Cotton and Linen Fabrics

Ultrasound assisted dyeing with disperse dyes for cellulose fabrics such as cotton and linen were conducted. In the dyeing bath, the ratio of dispersed dyes to fabric goods is 1:50 or more. Frequency and intensity of the ultrasound employed in this experiment were less than 25 KHz and 850 W respectively, and the ultrasound irradiating time was 20 minutes. The solution temperature arose by the cavitation was in the range of 60-70° C.

For comparison, a conventional direct dyeing method was conducted at 95° C. for 30 minutes. In the dyeing solution, the ratio of dispersed dyes to the goods to be dyed is the same as for ultrasound dyeing (i.e., 1:50), the ratio of common salt to dye is 10:1, and soda ash to dye is 0.25:1.

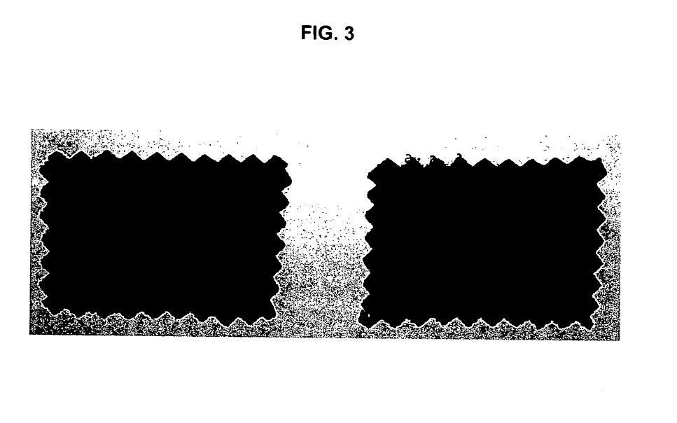

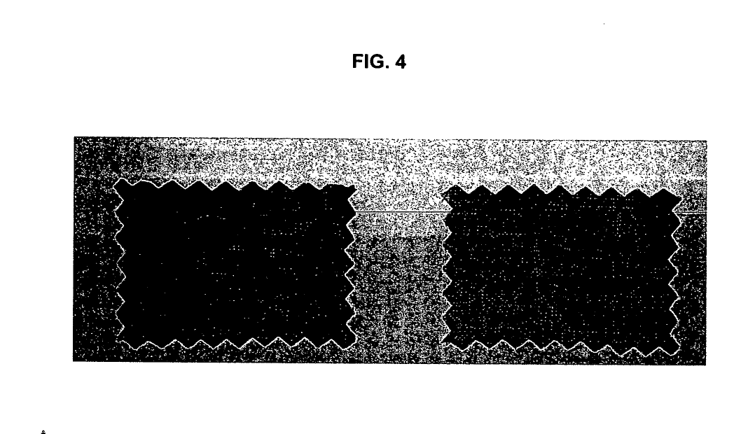

FIG. 3 shows the dyeing effect of ultrasound-assisted compared with the conventional direct dyeing method. The left side is the cotton fabric with the ultrasound dyeing method without heating for 20 minutes and the right side is the cotton fabric with conventional method at 95° C. for 30 minutes. FIG. 4 shows the dyeing effect of ultrasound-assisted compared with the conventional direct dyeing method. The left side is the linen fabric with ultrasound dyeing method without heating for 20 minutes; the right side is the linen fabric with the conventional method at 95° C. for 30 minutes.

Table 2 presents the color values of the dyed fabrics under conventional and ultrasound dyeing conducted similarly as in FIGS. 3 and 4 (except that the temperature was 98° C., instead of 95° C.). The results shown in FIGS. 3 and 4 and Table 2 all demonstrate that, for the both cotton and linen, the ultrasound dyeing with shorter time according to the present invention can give the same effect as the conventional ones with a higher temperatures and a longer time.

TABLE 2
Color values of the cotton and linen fabrics dyed under ultrasound
and conventional methods.

| Sample | | | | |
|---|---|---|---|---|
| Code | FABRIC | X | Y | Z |
| E | Cotton-98° C. | 19.079 | 21.743 | 47.964 |
| F | Cotton-Ultrasound | 18.742 | 21.485 | 47.044 |
| G | Linen-98° C. | 20.904 | 24.220 | 45.945 |
| H | Linen-Ultrasound | 20.026 | 23.137 | 44.407 |

Ultrasound-Assisted Acid Dyeing for Wool Fabric

Ultrasound assisted dyeing with acid dyes for wool fabric was conducted. In the dyeing solution, the ratio of dispersed dyes to goods to be dyed is 1:50. Frequency and intensity of the ultrasound employed in this experiment are 25 KHz and 850 W respectively, and the ultrasound irradiating time is 20 min. The solution temperature arose by the cavitation was in the range of 60-70° C.

For comparison, a conventional acid dyeing method was conducted at a high temperature, at about 98° C. for 30 minutes. In the dyeing solution, the ratio of dispersed dyes to goods to be dyed is the same as for ultrasound dyeing (i.e., 1:50), sulphuric acid to dye is 1.5:1, and glauber's salt to dye is 5:1.

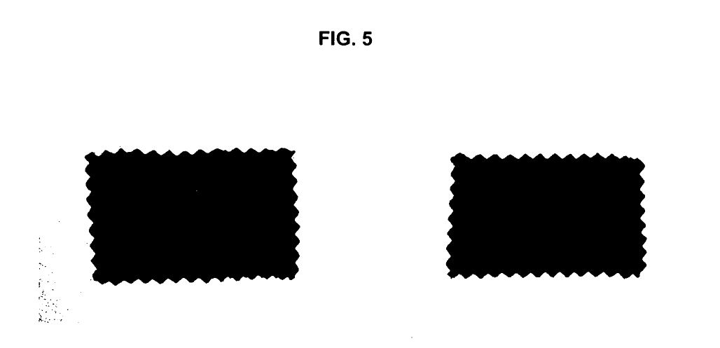

FIG. 5 shows the pictures of wool fabrics dyed under ultrasound compared with the conventional method. Table 3 presents the color values of the dyed wool fabrics under conventional and ultrasound dyeing. The results shown in FIG. 5 and Table 3 all demonstrate that the ultrasound dyeing process of the present invention with shorter time can give the same effect as the conventional method for a longer time at a high temperature.

TABLE 3
Color values of the wool fabrics dyed under ultrasound and
conventional methods.

| Sample | | | | |
|---|---|---|---|---|
| Code | FABRIC | X | Y | Z |
| I | Wool-98° C. | 5.087 | 5.277 | 18.924 |
| J | Wool-Ultrasound | 4.808 | 4.823 | 18.167 |

This is a great advantage offered by the present invention: a low temperature process (generally in the range of 50-70° C.) suitable for various types of fabric, including but not limited to, polyester, cotton, linen, wool. This low temperature ultrasound-assisted process achieves as satisfactory results as achievable by the conventional dyeing methods at near or above the boiling temperature. The dyeing process of the present invention can be further enhanced by pre-swelling the fabric in terms of reduced temperature, lower processing time and less need for chemicals. In addition, the dyeing process of the present invention allows real-time control of color shade by varying irradiation time as desired.

Ultrasound-Assisted Treatment Apparatus

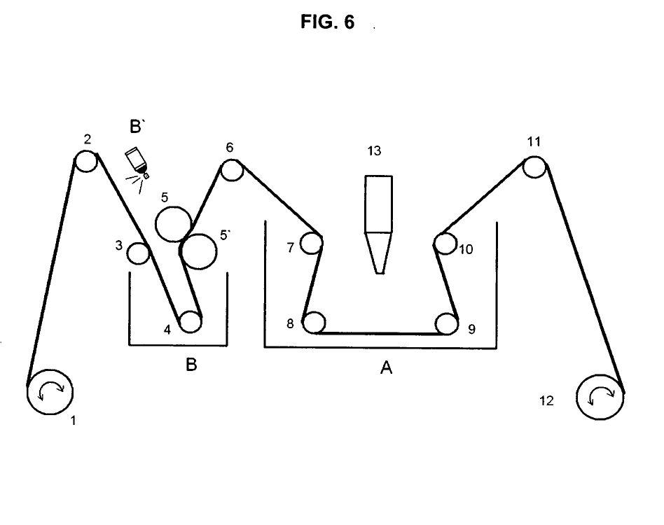

While conventional sonoreactor may be used for practicing the present invention and the construction of the sonoreactor is not part of the present invention, design of large-scale sonoreactors may take into consideration of the specifics peculiar to the wet-treatment process of the present invention, for example, the need to confine the articles under treatment within an optimal zone where the sonoreactor provides severe and uniform conditions of cavitation and at the same time operates at relatively lower frequencies, for example, less than 25 KHz. Nonetheless, this special consideration is within ordinary skill of the person skilled in the art. A single and multiple conventional transducers (different combinations of operating frequency and power) ultrasound dyeing machines were successfully used for operating in a batch mode or in a continuous mode, as shown in FIGS. 6-8, where the garments/fabrics/yarns/fibers can be maintained in a tensionless state during wet treatment.

FIG. 6 depicts ultrasound-assisted dyeing apparatus with single ultrasonic source wherein: Zone A is the main body of the dyeing apparatus with an ultrasonic horn 13. Zone B is for pretreatment where the fibers/yarns/fabrics/garments to be dyed are immersed in a swelling agent solution and then squeezed before going to the dyeing process in Zone A. Further, in Zone B′, the fibers/yarns/fabrics/garments can be additionally or alternatively sprayed with one or more swelling agents and squeezed before going to the dyeing process in Zone A. Different processes may be performed according to the type of the articles to be dyed. For example, a swelling pretreatment may be performed using either Zone B or B′. Or, no pretreatment is needed.

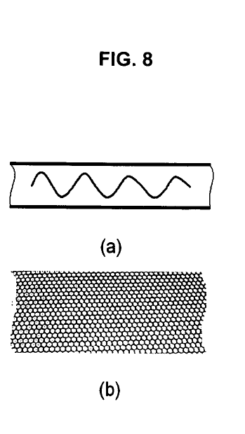

The apparatus shown in FIG. 6 is suitable for dyeing a small amount of goods in batch as well as in a continuous mode, in which the fibers/yams/fabrics/garments to be dyed are enveloped and sandwiched (FIG. 8a) between meshes (FIG. 8b) without exerting any tension on the articles under dyeing. Referring to FIG. 6, the numerical references 1 and 12 are driven rollers; 2-4 and 6-11 are guide rollers; 5 and 5′ are squeezing rollers; 13 is an ultrasonic horn (<25 KHz, power up to 900 W).

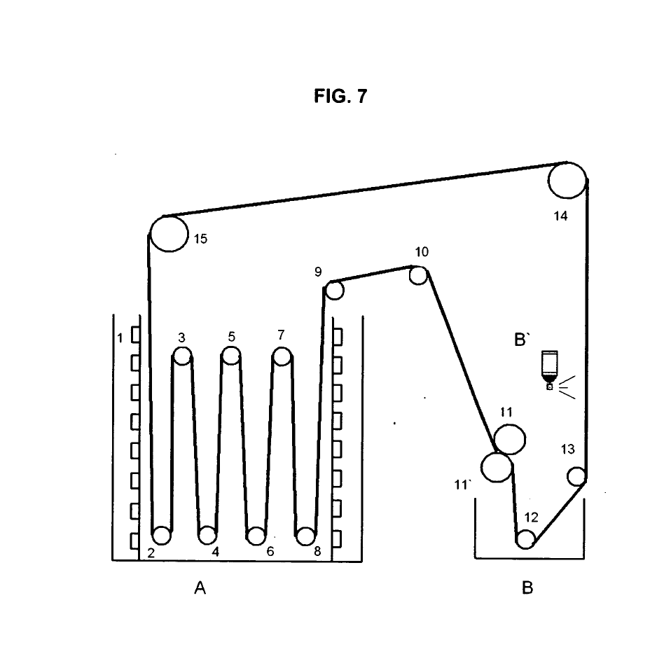

FIG. 7 shows another ultrasound-assisted dyeing apparatus with multiple ultrasonic sources suitable for practicing the present invention. Zone A is the main body of the dyeing apparatus with multiple ultrasonic transducers 1, on both sides. Zone B is the place where the fibers/yarns/fabrics/garments to be dyed are immersed in a solution containing swelling agents and then squeezed before going to the dyeing process. Zone B′ is an additional or alternative unit to spray the swelling agent to the fibers/yarns/fabrics/garments prior to being dyed in Zone A. Pretreatments using either Zone B or B′ will be performed according to the type of articles to be dyed. Although pretreatment was used in the particular embodiments shown above, it is optional. In general, for polyester, cotton and linen fabrics the swelling pretreatment may be used to achieve better results. For wool fabrics, on the other hand, such pretreatment may not enhance the result significantly.

The apparatus shown in FIG. 7 is suitable for dyeing a large amount of goods in batch as well as in a continuous mode. The fibers/yarns/fabrics/garments to be dyed are enveloped and sandwiched between meshes without any tension exerted to them as shown in FIG. 8. The numerical reference 1 refers to combinations of several ultrasonic transducers distributed on two sides of quadrate dyeing bath. 2-10, and 12-14 are guide rollers; 11 and 11′ are squeezing rollers; and 15 is a driven roller.

FIG. 8a is a cross-section view of the sandwich structure of the conveyor as used in FIGS. 6 and 7, showing that the fibers/yarns/fabrics/garments are enveloped and sandwiched between two layers of meshes without exerting any tension. FIG. 8 (b) is the top view of a typical mesh example.

With the method of the present invention, as described above, ultrasound energy is substantially and efficiently employed as a substitute either in whole or in part for the conventional needs of higher dyeing temperature, longer dyeing time and uses of chemical assistants. The method and apparatus lead to significantly reduce the dye temperature (50-70° C.) processing time, and consumption of auxiliary chemicals without degrading the coloration effect. Although the particular examples are for textile coloration, it can easily be understood by people with ordinary skill in the art that the method is applicable to other types of wet treatment of textiles. In summary, with the easy and generally applicable method and device of the present invention, natural and synthetic fibers/yarns/fabrics/garments may all be dyed (or undergone other types of wet treatment) at lower costs, thereby increasing industry competitiveness and meeting the market demand.

As used in this application, the article “a” means “one or more” unless it is specified otherwise, and the terms “sonoreactor” and “ultrasonic transducer” are used interchangeably. The term “textile” here means any fibers, yarns, fabrics or cloth, which are natural, synthetic or blend thereof, and “textile article” means any articles or goods made of textile as specially defined here. Examples of textile articles are garments and stuffed toys.

While there have been described and pointed out fundamental novel features of the invention as applied to a preferred embodiment thereof, it will be understood that various omissions and substitutions and changes, in the form and details of the embodiments illustrated, may be made by those skilled in the art without departing from the spirit of the invention. The invention is not limited by the embodiments described above which are presented as examples only but can be modified in various ways within the scope of protection defined by the appended patent claims.

What is claimed is:

1. A method for wet-treatment of textile or a textile article, comprising the steps of (a) adding a treatment solution in a container, (b) operating at least one sonoreactor located in or near said container, and (c) substantially confining textile or textile article to be wet-treated in said solution during wet treatment within a zone in said container where vigorous cavitations are generated by said sonoreactor; said steps (a)-(c) being performed in any order suitable for performing wet treatment.

2. The method of claim 1, wherein said wet-treatment is for coloration and said treatment solution comprises a dye.

3. The method of claim 2, wherein said sonoreactor is operating at a frequency equal to or lower than 25 KHz and, other than the heat generated by said sonoreactor during operation, no heating is employed.

4. The method of claim 1, wherein the temperature of said treatment solution during wet treatment is lower than 80° C.

5. The method of claim 4, wherein the temperature of said treatment solution is lower than 70° C.

6. The method of claim 1, wherein a conveyor belt is used for confining said textile or textile article within said zone in said container.

7. The method of claim 1, wherein a net having a fixed location in said container is used for confining said textile or textile article within said zone in said container, said net allowing said textile or textile article to contact with said treatment solution but constraining it within said zone.

8. The method of claim 6, wherein said conveyor belt comprises at least two layers of meshes between which said textile or textile article is contained.

9. The method of claim 1, wherein two or more sonoreactors are used, which operate at a same frequency or different frequencies.

10. The method of claim 3, further comprises a step of pre-treating said textile or textile article with a swelling agent.

11. An apparatus, comprising a container adapted for containing a treatment solution for wet-treatment of textile or textile articles, a constraint adapted for constraining textile or textile articles within a particular location in said container, and a sonoreactor positioned for generating cavitations in said particular location in said container.

12. The apparatus of claim 11, wherein said apparatus is used for coloration of textile or textile articles.

13. The apparatus of claim 11, wherein said sonoreactor is adapted for operating at a frequency equal to or lower than 25 kHz.

14. The apparatus of claim 11, wherein said constraint is a conveyor belt.

15. The apparatus of claim 11, wherein said constraint is a net fixed in a location within said container.

16. The apparatus of claim 14, wherein said conveyor belt comprises two layers of meshes between which said textile or textile articles are confined.

17. The apparatus of claim 16, wherein said apparatus is for coloration of textile or textile articles.

18. The apparatus of claim 17, further comprising a pretreatment unit.

19. The apparatus of claim 18, wherein said pretreatment unit is for applying a swelling agent to said textile or textile articles.

20. The method of claim 1, wherein said wet-treatment is for textile finishing.

21. The method of claim 20, wherein said textile finishing is surface treatment or particle functionalization.
